(19) United States
(12) Patent Application Publication
(10) Pub. No.: US 2017/0300498 A1
(43) Pub. Date: Oct. 19, 2017

(54) SYSTEM AND METHODS THEREOF FOR ADDING MULTIMEDIA CONTENT ELEMENTS TO CHANNELS BASED ON CONTEXT

(71) Applicant: Cortica, Ltd., TEL AVIV (IL)

(72) Inventors: Igal RAICHELGAUZ, Tel Aviv (IL); Karina ODINAEV, Tel Aviv (IL); Yehoshua Y ZEEVI, Haifa (IL)

(73) Assignee: Cortica, Ltd., TEL AVIV (IL)

(21) Appl. No.: 15/641,830

(22) Filed: Jul. 5, 2017

Related U.S. Application Data
(63) Continuation-in-part of application No. 15/474,019, filed on Mar. 30, 2017.
Application No. 15/474,019 is a continuation-in-part of application No. 13/770,603, filed on Feb. 19, 2013.
Application No. 13/770,603 is a continuation-in-part of application No. 13/624,397, filed on Sep. 21, 2012, now Pat. No. 9,191,626.
Application No. 13/624,397 is a continuation-in-part of application No. 13/344,400, filed on Jan. 5, 2012, now Pat. No. 8,959,037.
Application No. 13/344,400 is a continuation of application No. 12/434,221, filed on May 1, 2009, now Pat. No. 8,112,376.
Application No. 13/624,397 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 13/624,397 is a continuation-in-part of application No. 12/084,150, filed on Apr. 7, 2009, now Pat. No. 8,655,801.
(60) Provisional application No. 62/358,593, filed on Jul. 6, 2016.
(60) Provisional application No. 62/316,603, filed on Apr. 1, 2016.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30; H04N 21/466; H04N 21/2668; H04N 21/258; H04N 7/173; H04L 29/08; H04H 60/66; H04H 60/56; H04H 60/46; H04H 60/37; H04H 20/26; H04N 21/81; H04H 20/10

(52) U.S. Cl. CPC G06F 17/30056; H04N 21/8106; H04N 21/466; H04N 21/2668; H04N 21/25891; H04N 7/17318; H04H 20/103; H04H 60/66; H04H 60/56; H04H 60/46; H04H 60/37; H04H 20/26; H04L 67/10

(57) ABSTRACT

A system and method for generating channels of multimedia content element. The method includes correlating between a plurality of signatures of the multimedia content to determine a plurality of contexts; correlating the plurality of contexts to determine a plurality of assumptions for the multimedia content element; clustering the assumptions to create at least one story cluster characterizing a situation featured in the multimedia content element; and adding the multimedia content element to at least one channel, wherein the at least one channel is determined based on the at least one story cluster.

### CROSS-REFERENCE TO RELATED APPLICATIONS

This application claims the benefit of U.S. Provisional Application No. 62/358,593 filed on Jul. 6, 2016. This application is also a continuation-in-part of U.S. patent application Ser. No. 15/474,019 filed on Mar. 30, 2017, now pending, which claims the benefit of U.S. Provisional Application No. 62/316,603 filed on Apr. 1, 2016. The Ser. No. 15/474,019 application is also a continuation-in-part of U.S. patent application Ser. No. 13/770,603 filed on Feb. 19, 2013, now pending, which is a continuation-in-part (CIP) of U.S. patent application Ser. No. 13/624,397 filed on Sep. 21, 2012, now U.S. Pat. No. 9,191,626. The Ser. No. 13/624,397 application is a CIP of:

(a) U.S. patent application Ser. No. 13/344,400 filed on Jan. 5, 2012, now U.S. Pat. No. 8,959,037, which is a continuation of U.S. patent application Ser. No. 12/434,221 filed on May 1, 2009, now U.S. Pat. No. 8,112,376;

(b) U.S. patent application Ser. No. 12/195,863 filed on Aug. 21, 2008, now U.S. Pat. No. 8,326,775, which claims priority under 35 USC 119 from Israeli Application No. 185414, filed on Aug. 21, 2007, and which is also a continuation-in-part of the below-referenced U.S. patent application Ser. No. 12/084,150; and,

(c) U.S. patent application Ser. No. 12/084,150 having a filing date of Apr. 7, 2009, now U.S. Pat. No. 8,655,801, which is the National Stage of International Application No. PCT/IL2006/001235, filed on Oct. 26, 2006, which claims foreign priority from Israeli Application No. 171577 filed on Oct. 26, 2005, and Israeli Application No. 173409 filed on Jan. 29, 2006.

All of the applications referenced above are herein incorporated by reference.

### TECHNICAL FIELD

The present disclosure relates generally to contextual analysis of multimedia content elements, and more specifically to generating channels of multimedia content elements based on context.

### BACKGROUND

Since the advent of digital photography and, in particular, after the rise of social networks, the Internet has become inundated with uploaded images, videos, and other content.

Due to the large amount of content available online, people generally only look at a small fraction of the content that their contacts in the social network publish. In an effort to address the problem, some people manually tag multimedia content in order to indicate subject matter of such content in an effort to encourage users seeking content featuring the tagged subject matter to view the tagged content. The tags may be textual or other identifiers included in metadata of the multimedia content, thereby associating the textual identifiers with the multimedia content. Users may subsequently search for multimedia content elements with respect to tags by providing queries indicating desired subject matter. Tags therefore make it easier for users to find content related to a particular topic.

A popular textual tag is the hashtag. A hashtag is a type of label typically used on social networking websites, chats, forums, microblogging services, content sharing services, and the like. Users create and use hashtags by placing the hash character (or number sign) # in front of a word or unspaced phrase, either in the main text of a message associated with content, or at the end. Searching for that hashtag will then present each message and, consequently, each multimedia content element, that has been tagged with it. Accordingly, tags may be utilized to categorize multimedia content. Specifically, tags may be used to identify relevant content to be added to channels of multimedia content.

Accurate and complete listings of tags can massively increase exposure of certain multimedia content to users. However, tags are often inaccurate or incomplete, particularly when provided by a user. Further, although some automatic tagging solutions exist, such solutions face challenges in efficiently and accurately identifying subject matter of multimedia content. Moreover, such solutions typically only recognize superficial expressions of subject matter in multimedia content and, therefore, fail to account for context in tagging multimedia content. Thus, channels created using tags may include irrelevant content, or relevant content may be left out of the channels.

It would be therefore advantageous to provide a solution for accurately generating channels of contextually related multimedia content element.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for adding multimedia content elements to channels based on context. The method comprises: correlating between a plurality of signatures of the multimedia content to determine a plurality of contexts; correlating the plurality of contexts to determine a plurality of assumptions for the multimedia content element; clustering the assumptions to create at least one story cluster characterizing a situation featured in the multimedia content element; and adding the multimedia content element to at least one channel, wherein the at least one channel is determined based on the at least one story cluster.

Certain embodiments disclosed herein also include a non-transitory computer readable medium having stored thereon instructions causing a processing circuitry to execute a process, the process comprising: correlating between a plurality of signatures of the multimedia content to determine a plurality of contexts; correlating the plurality of contexts to determine a plurality of assumptions for the multimedia content element; clustering the assumptions to create at least one story cluster characterizing a situation featured in the multimedia content element; and adding the multimedia content element to at least one channel, wherein the at least one channel is determined based on the at least one story cluster.

Certain embodiments disclosed herein also include a system for adding multimedia content elements to channels based on context. The system comprises: a processing circuitry; and a memory connected to the processing circuitry, the memory containing instructions that, when executed by the processing circuitry, configure the system to: correlate between a plurality of signatures of the multimedia content to determine a plurality of contexts; correlate the plurality of contexts to determine a plurality of assumptions for the multimedia content element; cluster the assumptions to create at least one story cluster characterizing a situation featured in the multimedia content element; and add the multimedia content element to at least one channel, wherein the at least one channel is determined based on the at least one story cluster.

### BRIEF DESCRIPTION OF THE DRAWINGS

The subject matter that is regarded as the disclosure is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments herein.

FIG. 2 is a flowchart illustrating a method for adding multimedia content elements to channels based on context according to an embodiment.

FIG. 3 is a flowchart illustrating a method for determining a channel for a multimedia content element according to an embodiment.

FIG. 4 is a block diagram depicting the basic flow of information in the signature generator system.

FIG. 5 is a diagram showing the flow of patches generation, response vector generation, and signature generation in a large-scale speech-to-text system.

FIG. 6 is a block diagram of a channel creator according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

A system and method for generating channels of multimedia content elements based on context are disclosed. Signatures are generated for an input multimedia content element. Each of the generated signatures represents a concept. The concepts of the generated signatures are correlated. Based on the correlation, contexts of the input multimedia content element are determined. Assumptions are generated based on the at least one context. The assumptions are clustered into a story cluster. The input multimedia content elements is added to a channel of multimedia content elements based on the story cluster.

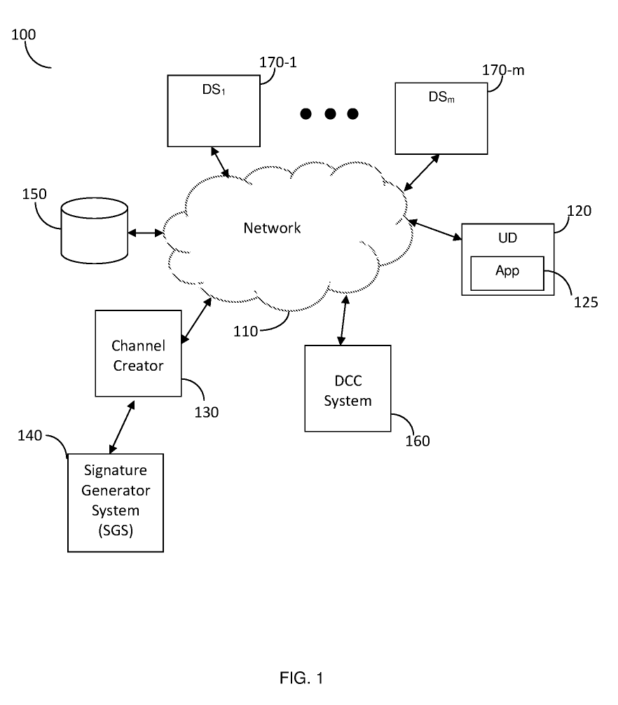

FIG. 1 is an example network diagram 100 utilized to describe the various embodiments disclosed. The network diagram 100 includes a user device 120, a channel creator 130, a database 150, a deep content classification (DCC) system 160, and a plurality of data sources 170-1 through 170-m (hereinafter referred to individually as a data source 170 and collectively as data sources 170, merely for simplicity purposes) communicatively connected via a network 110. The network 110 may be, but is not limited to, the Internet, the world-wide-web (WWW), a local area network (LAN), a wide area network (WAN), a metro area network (MAN), and other networks capable of enabling communication between the elements of the network diagram 100.

The user device 120 may be, but is not limited to, a personal computer (PC), a personal digital assistant (PDA), a mobile phone, a smart phone, a tablet computer, a wearable computing device and other kinds of wired and mobile appliances, equipped with browsing, viewing, listening, filtering, managing, and other capabilities that are enabled as further discussed herein below. The user device 120 may have installed thereon an application 125 such as, but not limited to, a web browser. The application 125 may be configured to store multimedia content elements in, for example, the data sources 170. For example, the application 125 may be a web browser through which a user of the user device 120 accesses a social media website and uploads multimedia content elements when one of the data sources 170 is associated with the social media website.

The database 150 may be a context database storing information such as, but not limited to, multimedia content elements, clusters of multimedia content elements, previously determined contexts, signatures previously analyzed, a combination thereof, and the like. The database 150 may further store concepts, where the concepts may represent the previously determined contexts.

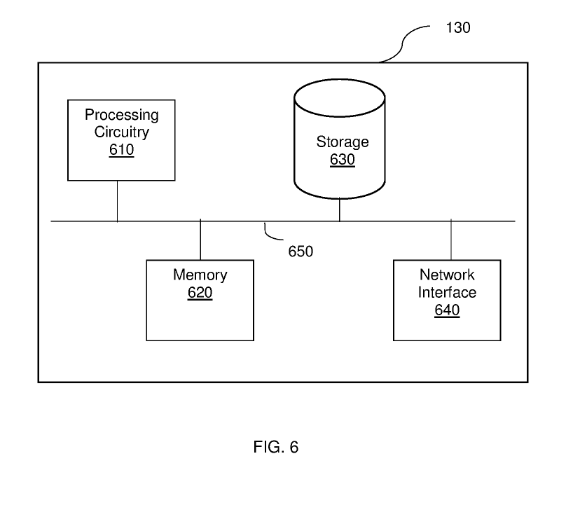

In an embodiment, the channel creator 130 includes a processing circuitry coupled to a memory (e.g., the processing circuitry 610 and the memory 620 as shown in FIG. 6). The memory contains instructions that can be executed by the processing circuitry. In a further embodiment the channel creator 130 may include an array of at least partially statistically independent computational cores configured as described in more detail herein below.

In an embodiment, the channel creator 130 is communicatively connected to a signature generator system (SGS) 140, which is utilized by the channel creator 130 to perform the various disclosed embodiments. Specifically, the signature generator system 140 is configured to generate signatures to multimedia content elements and includes a plurality of computational cores, each computational core having properties that are at least partially statistically independent of each other core, where the properties of each core are set independently of the properties of each other core.

The signature generator system 140 may be communicatively connected to the channel creator 130 directly (as shown), or through the network 110 (not shown). In another embodiment, the channel creator 130 may further include the signature generator system 140, thereby allowing the channel creator 130 to generate signatures for multimedia content elements.

In an embodiment, the channel creator 130 is communicatively connected to the deep content classification system 160, which is utilized by the channel creator 130 to perform the various disclosed embodiments. Specifically, the deep content classification system 160 is configured to create, automatically and in an unsupervised fashion, concepts for a wide variety of multimedia content elements. To this end, the deep content classification system 160 may be configured to inter-match patterns between signatures for a plurality of multimedia content elements and to cluster the signatures based on the inter-matching. The deep content classification system 160 may be further configured to reduce the number of signatures in a cluster to a minimum that maintains matching and enables generalization to new multimedia content elements. Metadata of the multimedia content elements is collected to form, together with the reduced clusters, a concept. An example deep content classification system is described further in U.S. Pat. No. 8,266,185, assigned to the common assignee, the contents of which are hereby incorporated by reference.

The deep content classification system 160 may be communicatively connected to the channel creator 130 directly (not shown), or through the network 110 (as shown). In another embodiment, the channel creator 130 may further include the deep content classification system 160, thereby allowing the channel creator 130 to create a concept database and to match concepts from the concept database to multimedia content elements.

In an embodiment, the channel creator 130 is configured to receive, from the user device 120, an input multimedia content element to be added to a channel. In another embodiment, the channel creator 130 is configured to receive, from the user device 120, an indicator of a location of the input multimedia content element in storage (e.g., in the data source 170). In a further embodiment, the channel creator 130 is configured to retrieve the input multimedia content element based on the indicator. A multimedia content element may be, but is not limited to, an image, a graphic, a video stream, a video clip, an audio stream, an audio clip, a video frame, a photograph, an image of signals (e.g., spectrograms, phasograms, scalograms, etc.), combinations thereof, portions thereof, and the like.

In an embodiment, the channel creator 130 is configured to send the input multimedia content element to the signature generator system 140, to the deep content classification system 160, or both. In a further embodiment, the channel creator 130 is configured to receive a plurality of signatures generated from the input multimedia content element by the signature generator system 140, to receive a plurality of signatures (e.g., signature reduced clusters) of concepts matched to the input multimedia content element from the deep content classification system 160, or both. In another embodiment, the channel creator 130 may be configured to generate the plurality of signatures, to identify the plurality of signatures (e.g., by determining concepts associated with the signature reduced clusters matching the input multimedia content element), or a combination thereof.

Each signature represents a concept, and may be robust to noise and distortion. Each concept is a collection of signatures representing multimedia content elements and metadata describing the concept, and acts as an abstract description of the content to which the signature was generated. As a non-limiting example, a ‘Superman concept’ is a signature-reduced cluster of signatures describing elements (such as multimedia elements) related to, e.g., a Superman cartoon: a set of metadata containing textual representation of the Superman concept. As another example, metadata of a concept represented by the signature generated for a picture showing a bouquet of red roses is “flowers”. As yet another example, metadata of a concept represented by the signature generated for a picture showing a bouquet of wilted roses is “wilted flowers”. The signatures, generated as described herein, may be robust to noise, distortion, or both, thereby allowing for more accurate identification of multimedia content elements.

In an embodiment, the channel creator 130 is configured to correlate among the received signatures of the input multimedia content element and to determine, based on the correlation, contexts of the multimedia content element. Each context is determined by correlating among the plurality of signatures of the multimedia content element. A context is determined as the correlation between a plurality of concepts. A strong context may be determined, e.g., when there are at least a threshold number of concepts that satisfy the same predefined condition. As a non-limiting example, by correlating a signature of a person in a baseball uniform with a signature of a baseball stadium, a context representing a “baseball player” may be determined. Correlations among the concepts of a plurality of multimedia content elements can be achieved using probabilistic models by, e.g., identifying a ratio between signatures' sizes, a spatial location of each signature, and the like. Determining contexts for multimedia content elements is described further in the above-referenced U.S. patent application Ser. No. 13/770,603.

It should be noted that using signatures for determining the context ensures more accurate determining which channels to add multimedia content elements than, for example, based on metadata alone.

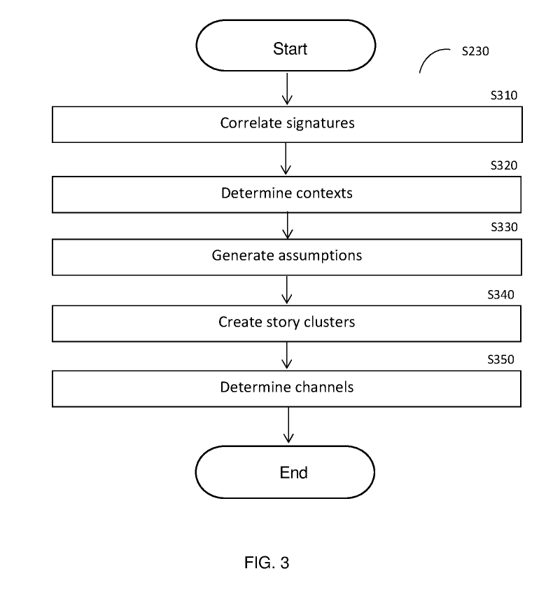

In an embodiment, the channel creator 130 is configured to determine a channel to which the input multimedia content element should be added based on the determined contexts. To this end, the channel creator 130 may be configured to generate assumptions based on the determined contexts, and to cluster the assumptions to create at least one story cluster. Each story cluster is a cluster of assumptions characterizing a situation featured in the input multimedia content element. For example, a story cluster for an image showing four people smiling in bathing suits in front of an ocean may characterize a situation “friends at the beach.” Creating story clusters to determine channels for a multimedia content element is described further herein below with respect to FIG. 3.

It should be noted that only one user device 120 and one application 125 are described herein above with reference to FIG. 1 merely for the sake of simplicity and without limitation on the disclosed embodiments. Multiple user devices may provide input multimedia content elements via multiple applications 125, and channels for each multimedia content element is to be added may be determined without departing from the scope of the disclosure.

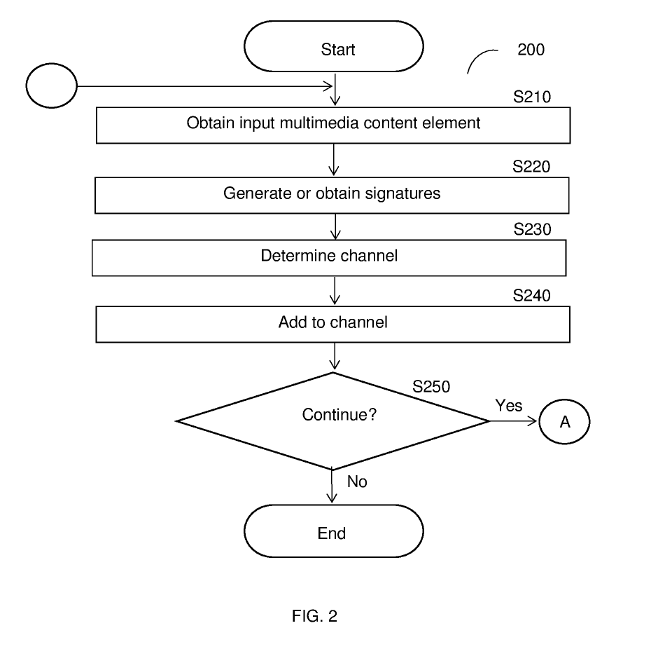

FIG. 2 depicts an example flowchart 200 illustrating a method for generating channels of multimedia content elements according to an embodiment. In an embodiment, the method may be performed by the channel creator 130.

At S210, an input multimedia content element to be added to one or more channels is obtained. In an embodiment, S210 may include receiving a request including the input multimedia content element. Alternatively, the input multimedia content element may be retrieved from one or more data sources. The input multimedia content element may be indicated in a request to add the input multimedia content element to a channel, or may be a newly added multimedia content element to be automatically added to appropriate channels.

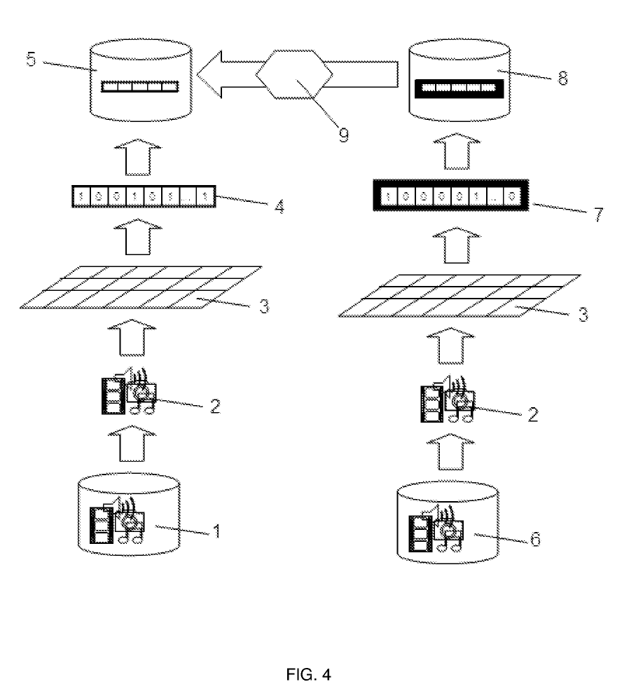

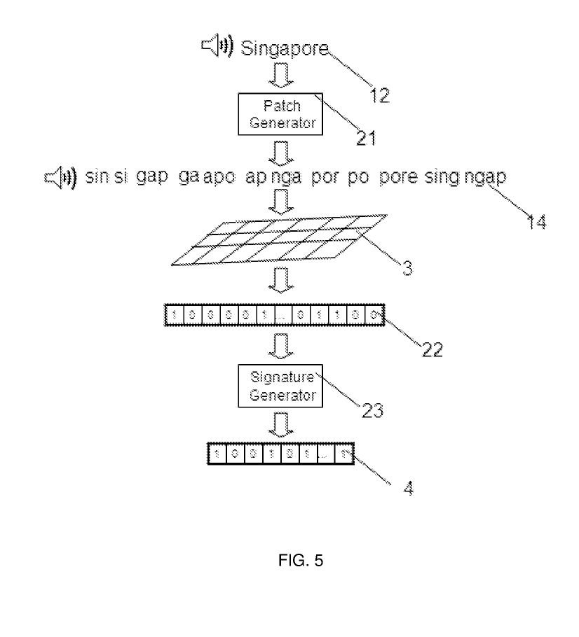

At S220, signatures are generated or obtained for the input multimedia content element. The signatures are generated as described below with respect to FIGS. 4 and 5. The signatures may be robust to noise and distortion. The signatures include signatures generated based on content of the input multimedia content elements, and may further include signatures generated based on metadata of the input multimedia content elements.

In an embodiment, S220 includes generating the signatures via a plurality of at least partially statistically independent computational cores, where the properties of each core are set independently of the properties of the other cores. In another embodiment, S220 includes sending the input multimedia content element to a signature generator system, to a deep content classification system, or both, and receiving the plurality of signatures. The signature generator system includes a plurality of at least statistically independent computational cores as described further herein. The deep content classification system is configured to create concepts for a wide variety of multimedia content elements, automatically and in an unsupervised fashion.

At S230, a channel is determined for the input multimedia content element. The determined channel is associated with a story demonstrated by the input multimedia content element as represented by a story cluster determined for the multimedia content element. In an embodiment, S230 includes correlating between concepts of the signatures generated or obtained at S220 and determining, based on the correlations, contexts of the input multimedia content elements. Based on the determined contexts, assumptions representing interaction points between the contexts may be generated and clustered to create at least one story cluster. In a further embodiment, S230 also includes searching for the at least one channel based on the story clusters. Determining channels for multimedia content elements is described further herein below with respect to FIG. 3.

The determined channel may be an existing channel associated with a story cluster matching the determined story cluster. If no existing channel having a matching story is found, S230 may include generating a new channel associated with the determined story cluster and including the input multimedia content element.

At S240, the input multimedia content element is added to the determined channel. In an embodiment, S240 may further include providing the channel including the added input multimedia content elements to a user. To this end, S240 may include sending the channel to, for example, a user device (e.g., a user device that sent the input multimedia content element, a user device associated with a user profile indicating interest in the determined story cluster, etc.). The channel may also be subsequently accessed by users looking for channels based on a subject of interest.

In S250, it is checked whether additional input multimedia content elements are to be added to channels and, if so, execution continues with S210; otherwise, execution terminates.

It should be noted that FIG. 2 is described herein as adding the input multimedia content element to a single channel merely for simplicity purposes and without limitation on the disclosed embodiments. An input multimedia content element may be added to multiple channels without departing from the scope of the disclosure.

FIG. 3 depicts an example flowchart S230 illustrating a method for determining a channel to which a multimedia content element is to be added according to an embodiment. In an embodiment, the method is performed based on a plurality of signatures representing concepts of the multimedia content element, of metadata of the multimedia content element, or both.

At S310, signatures for the multimedia content element are correlated. In an embodiment, S310 includes correlating among the concepts of a plurality of multimedia content elements using probabilistic models by, e.g., identifying a ratio between signatures' sizes, a spatial location of each signature, and the like. In an embodiment, S310 may further include querying a DCC system with the signatures. The deep content classification system may be configured to identify and return at least one matching concept. Utilizing signatures of matching concepts may allow for, e.g., identification of specific people that are known. For example, signatures representing a face of the football player Peyton Manning may be included in a concept representing Peyton Manning such that a signature for a concept matching an image including Peyton Manning represents the concept of “Peyton Manning.”

At S320, based on the correlation, contexts of the multimedia content element are determined. A context is determined as the correlation between a plurality of concepts. A strong context may be determined, e.g., when there are at least a threshold number of concepts that satisfy the same predefined condition.

At S330, based on the determined contexts, assumptions for the multimedia content element are generated. Each assumption indicates a point of interaction between two or more contexts and may be determined by, e.g., matching signatures representing each set of two of the contexts. To this end, each assumption may include at least a portion of a signature representing a common portion of signatures of the respective contexts.

At S340, the assumptions are clustered to create at least one story cluster for the multimedia content element. The story cluster is a cluster of assumptions that characterizes a situation illustrated in the multimedia content element.

At S350, the created story clusters are compared to story clusters associated with channels to determine at least one channel to associated with a story cluster matching the story cluster of the multimedia content element.

In an embodiment, if no channel is associated with a matching story cluster, one or more new channels may be generated and associated with one of the determined story clusters. Each generated channel includes the input multimedia content element. Further, one or more tags may be recommended for the channel based on the multimedia content elements of the channel. An example method for recommending tags for multimedia content elements based on contexts is described in U.S. patent application Ser. No. 15/474,019 filed on Mar. 30, 2017, assigned to the common assignee, the contents of which are hereby incorporated by reference.

As a non-limiting example, signatures of an input video showing two men shaking hands in an office are correlated to determine contexts. The signatures include signatures representing the two men, the handshake, the office environment, business suits worn by the two men, and the concepts of Microsoft® and Google® (e.g., as identified by matching signatures of the input video representing Microsoft® and Google® logos to signatures of a DCC). Contexts representing a Microsoft® businessman, a Google® business man, and a business deal are determined based on the signatures. Assumptions indicating a Microsoft® businessman making a deal and indicating a Google® businessman making a deal are generated. The assumptions are clustered to create a story cluster “deal between Microsoft® and Google®.” A channel including news video clips related to the deal between Microsoft® and Google® may be determined by matching the story cluster to story clusters associated with channels.

FIGS. 4 and 5 illustrate the generation of signatures for the multimedia content elements by the SGS 140 according to one embodiment. An exemplary high-level description of the process for large scale matching is depicted in FIG. 4. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames. In an embodiment the server 130 is configured with a plurality of computational cores to perform matching between signatures.

The Signatures' generation process is now described with reference to FIG. 5. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the server 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={nᵢ} (1≦i≦L) may consist of a single leaky integrate-to-threshold unit (LTU) node or more nodes. The node nᵢ equations are:

$${V}_{i} {\sum }_{j}^{ } {w}_{ij} {k}_{j}$$

$${n}_{i} = θ ( Vi - {Th}_{x} )$$

where, θ is a Heaviside step function; wᵢⱼ is a coupling node unit (CNU) between node i and image component j (for example, grayscale value of a certain pixel j); kj is an image component ‘j’ (for example, grayscale value of a certain pixel j); Thx is a constant Threshold value, where ‘x’ is ‘S’ for Signature and ‘RS’ for Robust Signature; and Vi is a Coupling Node Value.

The Threshold values Thx are set differently for Signature generation and for Robust Signature generation. For example, for a certain distribution of Vi values (for the set of nodes), the thresholds for Signature (Th_{S}) and Robust Signature (Th_{RS}) are set apart, after optimization, according to at least one or more of the following criteria:
1: For: Vᵢ>Th_{RS}
   1−p(V>Th_{S})−1−(1−ε)^{l}<<1
      i.e., given that l nodes (cores) constitute a Robust Signature of a certain image I, the probability that not all of these I nodes will belong to the Signature of same, but noisy image, Ĩ is sufficiently low (according to a system's specified accuracy).
2: p(Vᵢ>Th_{RS})≈l/L
   i.e., approximately l out of the total L nodes can be found to generate a Robust Signature according to the above definition.
3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found in U.S. Pat. Nos. 8,326,775 and 8,312,031, assigned to the common assignee, which are hereby incorporated by reference.

A Computational Core generation is a process of definition, selection, and tuning of the parameters of the cores for a certain realization in a specific system and application. The process is based on several design considerations, such as:

(a) The Cores should be designed so as to obtain maximal independence, i.e., the projection from a signal space should generate a maximal pair-wise distance between any two cores' projections into a high-dimensional space.

(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.

(c) The Cores should be optimally designed with regard to invariance to a set of signal distortions, of interest in relevant applications.

A detailed description of the Computational Core generation and the process for configuring such cores is discussed in more detail in the co-pending U.S. patent application Ser. No. 12/084,150 referenced above.

FIG. 6 is an example block diagram of the channel creator 130 according to an embodiment. The channel creator 130 includes a processing circuitry 610 coupled to a memory 620, a storage 630, and a network interface 640. In an embodiment, the components of the channel creator 130 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information. In an embodiment, the processing circuitry 610 may be realized as an array of at least partially statistically independent computational cores. The properties of each computational core are set independently of those of each other core, as described further herein above.

The memory 620 may be volatile (e.g., RAM, etc.), non-volatile (e.g., ROM, flash memory, etc.), or a combination thereof. In one configuration, computer readable instructions to implement one or more embodiments disclosed herein may be stored in the storage 630.

In another embodiment, the memory 620 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein. Specifically, the instructions, when executed, cause the processing circuitry 610 to provide recommendations of trending content based on context as described herein.

The storage 630 may be magnetic storage, optical storage, and the like, and may be realized, for example, as flash memory or other memory technology, CD-ROM, Digital Versatile Disks (DVDs), or any other medium which can be used to store the desired information.

The network interface 640 allows the channel creator 130 to communicate with the signature generator system 140 for the purpose of, for example, sending multimedia content elements, receiving signatures, and the like. Further, the network interface 640 allows the channel creator 130 to communicate with the user device 120 for the purpose of, for example, receiving multimedia content elements, sending channels, and the like.

It should be understood that the embodiments described herein are not limited to the specific architecture illustrated in FIG. 6, and other architectures may be equally used without departing from the scope of the disclosed embodiments. In particular, the channel creator 130 may further include a signature generator system configured to generate signatures as described herein without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the disclosed embodiments and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

What is claimed is:

1. A method for adding a multimedia content element to at least one channel based on context, comprising:
correlating between a plurality of signatures of the multimedia content to determine a plurality of contexts;
correlating the plurality of contexts to determine a plurality of assumptions for the multimedia content element;
clustering the assumptions to create at least one story cluster characterizing a situation featured in the multimedia content element; and
adding the multimedia content element to at least one channel, wherein the at least one channel is determined based on the at least one story cluster.

2. The method of claim 1, wherein each of the signatures represents a concept, wherein each concept is a collection of signatures and metadata representing the concept.

3. The method of claim 1, wherein each assumption indicates a point of interaction between at least two of the determined contexts.

4. The method of claim 1, further comprising:
generating, by a signature generator system, the plurality of signatures for the multimedia content element, wherein the signature generator system includes a plurality of at least partially statistically independent computational cores, wherein the properties of each core are set independently of the properties of each other core.

5. The method of claim 1, further comprising:
sending, to a deep content classification system, the multimedia content element, wherein the deep content classification system is configured to create concepts for a wide variety of multimedia content elements; and
receiving, from the deep content classification system, the plurality of signatures, wherein the plurality of signatures includes signature reduced clusters representing concepts related to the multimedia content element.

6. The method of claim 1, wherein the context is determined as the correlation between a plurality of concepts represented by the obtained plurality of signatures.

7. A non-transitory computer readable medium having stored thereon instructions for causing a processing circuitry to execute a process, the process comprising:
correlating between a plurality of signatures of the multimedia content to determine a plurality of contexts;
correlating the plurality of contexts to determine a plurality of assumptions for the multimedia content element;
clustering the assumptions to create at least one story cluster characterizing a situation featured in the multimedia content element; and
adding the multimedia content element to at least one channel, wherein the at least one channel is determined based on the at least one story cluster.

8. A system for adding a multimedia content element to at least one channel based on context, comprising:
a processing circuitry; and
a memory connected to the processing circuitry, the memory containing instructions that, when executed by the processing circuitry, configure the system to:
correlate between a plurality of signatures of the multimedia content to determine a plurality of contexts;
correlate the plurality of contexts to determine a plurality of assumptions for the multimedia content element;
cluster the assumptions to create at least one story cluster characterizing a situation featured in the multimedia content element; and
add the multimedia content element to at least one channel, wherein the at least one channel is determined based on the at least one story cluster.

9. The system of claim 8, wherein each of the signatures represents a concept, wherein each concept is a collection of signatures and metadata representing the concept.

10. The system of claim 8, wherein each assumption indicates a point of interaction between at least two of the determined contexts.

11. The system of claim 8, wherein the system is further configured to:
generate, by a signature generator system, the plurality of signatures for the multimedia content element, wherein the signature generator system includes a plurality of at least partially statistically independent computational cores, wherein the properties of each core are set independently of the properties of each other core.

12. The system of claim 8, wherein the system is further configured to:
send, to a deep content classification system, the multimedia content element, wherein the deep content classification system is configured to create concepts for a wide variety of multimedia content elements; and
receive, from the deep content classification system, the plurality of signatures, wherein the plurality of signatures includes signature reduced clusters representing concepts related to the multimedia content element.

13. The system of claim 8, wherein the context is determined as the correlation between a plurality of concepts represented by the obtained plurality of signatures.
